(19) United States
(12) Patent Application Publication
(10) Pub. No.: US 2002/0053196 A1
(43) Pub. Date: May 9, 2002

(54) Gas pipeline compressor stations with kalina cycles

(76) Inventors: Yakov Lerner, Foster City, CA (US); Mark Mirolli, Half Moon Bay, CA (US); Richard Pelletier, Livermore, CA (US)

Correspondence Address: Rajiv Yadav, McCutchen, Doyle, Brown & Enersen, LLP, Three Embarcadero Center, 18th Floor, San Francisco, CA, 94111, US

(21) Appl. No.: 09/938,284

(22) Filed: Aug. 23, 2001

Related U.S. Application Data
(60) Provisional application No. 60/246,251, filed on Nov. 6, 2000.

(51) Int. Cl. F02G 1/00

(52) U.S. Cl. 60/39.182

(57) ABSTRACT

An improved apparatus and method for transporting gas through long pipelines is provided. The invention provides a binary mixture (e.g. ammonia-water) KALINA CYCLE® that is used as a bottoming cycle with a gas turbine. The non-isothermal boiling and condensation of the binary mixture achieves a high degree of recuperation. By throttling a part of the binary mixture, cooling is provided to the inlet air chiller for the gas turbine air compressor, which significantly improves the performance of the gas turbine. Thus, the invention provides a system for inlet air chilling integrated into a gas turbine-KALINA CYCLE® combined cycle used in a gas pipeline compressor station for pumping natural gas.

### RELATED APPLICATION DATA

This application claims the benefit of the filing date of U.S. provisional patent application No. 60/246,251, filed Nov. 6, 2000.

### FIELD OF THE INVENTION

This invention relates to an apparatus and method for transportation of gaseous fluids over long distances and particularly to an improved method and system for compressing natural gas in a compressor station for a gas pipeline.

### BACKGROUND OF THE INVENTION

Natural gas is transported today in very large quantities frequently over distances of several thousand kilometers in large gas pipelines to the centers of consumption. For example, such long-distance gas pipelines may have a diameter of 56 inches and may be operated with gas pressures of 75 bar to about 200 bar, in order to achieve a transportation capacity which is as large as possible. To compensate for the unavoidable pressure loss along the gas pipelines, compressor stations must be provided at certain intervals (typically, about 100 to 200 kilometers apart) for increasing the gas pressure back to the nominal pressure. As a rule, the compressors used for this purpose, usually turbo compressors, are driven by gas turbines which use a portion of the transported natural gas as fuel.

Because pipelines transporting gas often are thousands of kilometers long, a number of compressor stations are needed, which consume a significant amount of energy. To improve the efficiency of the compressor stations, the high temperature exhaust gases from the gas turbines which drive the compressors are used for producing steam or other motive fluid in a heat recovery vapor generator (HRVG). The steam or other vapor is then used to drive a turbine, which in turn drives other compressors. This technology can be used to reduce the amount of gas used in the compressor stations by about 20%. See U.S. Pat. No. 4,420,950.

Even with such bottoming cycles coupled to gas turbines to improve energy efficiency, a relatively large fraction of the gas to be transported is used up as fuel for the gas turbine driven compressors. Therefore, there is a need to further improve the efficiency of gas turbine driven compressor stations.

### SUMMARY OF THE INVENTION

The present invention satisfies the aforementioned need by providing an improved apparatus and method for transporting gas through long pipelines. The invention provides a binary mixture (e.g. ammonia-water) KALINA CYCLE® that is used as a bottoming cycle with a gas turbine. The non-isothermal boiling and condensation of the binary mixture achieves a high degree of recuperation. Further, the invention provides for throttling a part of the binary mixture to provide cooling for an inlet air chiller for the gas turbine, which significantly improves the performance of the gas turbine. Thus, the invention provides a system for inlet air chilling integrated into a gas turbine-KALINA CYCLE® combined cycle for use in a gas pipeline compressor stations for pumping natural gas.

### BRIEF DESCRIPTION OF THE DRAWINGS

FIG. 1 is a schematic representation of systems for carrying out two embodiments of the method and apparatus of the present invention.

FIG. 1A shows a single gas-turbine system whereas

FIG. 1B shows a multi-unit system.

FIG. 2 provides a conceptual flow diagram of one bottoming cycle and air chiller arrangement that can be used in the present invention, for example, as the bottoming cycle and air chiller of the embodiments shown in FIG. 1.

### DETAILED DESCRIPTION OF THE PREFERRED EMBODIMENTS

The invention provides a method and equipment for compressing gas in a compressor station for a gas pipeline, wherein the gas is supplied in the gas pipeline to the compressor station at an entry pressure and the gas is returned to the pipeline for further transportation in the pipeline at an exit temperature and at an exit pressure which is higher than the entry pressure. Gas compression is done using gas turbine driven compressors. Specifically, the present invention provides a novel method for pumping natural gas through gas pipelines by combining gas turbine operations with a binary cycle, specifically, the KALINA CYCLE®, which not only serves as a bottoming cycle to provide a highly efficient combined cycle but also provides a system to cool the inlet air for the gas turbine compressor to increase the efficiency of the gas turbine.

The KALINA CYCLE® is an alternative technology to the Rankine cycle. Conventional Rankine-cycle thermal power plants convert thermal energy into electric energy using a working fluid that absorbs the heat in a boiler and, in a subsequent step, releases the energy through a vapor turbine. Conventional Rankine cycle plants use a single component working fluid, such as water. The KALINA CYCLE®, on the other hand, uses a binary mixture, such as an ammonia-water mixture, as the working fluid. The use of a binary working fluid mixture allows the composition of the working fluid to be varied throughout the cycle, enabling highly efficient power cycles with a high level of heat recovery.

Many different versions of the KALINA CYCLE® have been developed and are described in the following U.S. patents, all of which are incorporated herein by reference: U.S. Pat. Nos. 4,489,563; 4,548,043; 4,586,340; 4,604,867; 4,732,005; 4,763,480; 4,899,545; 4,982,568; 5,095,708; 5,029,444; 5,440,882; 5,572,871; 5,649,426; 5,822,990; and 5,953,918.

Gas turbines, commonly used to provide the motive force for pumping natural gas, are widely available and many references provide an excellent description of this technology, including Perry's Chemical Engineer's Handbook, Seventh Edition, McGraw-Hill, 1997, pp. 29-29 to 29-41, which is incorporated by reference herein. Such arrangements generally involve: a compressor, which takes ambient air and compresses it to about 15-20 bar, increasing the temperature to about 600-700° F. (315-371° C.); a combustor, through which the compressed air passes, which increases the temperature of the gases to at least about 2000-2200° F. (1080-1190° C.); and, an expander, in which the gases are expanded to about ambient pressure with a typical temperature reduction to about 850-1000° F. (about 450-540° C.). Energy released during the expansion process is used to drive a compressor for compressing a fluid or a generator, for production of power.

Typical gas turbines are rated for percent of design output, percent of design air flow and percent of design heat rate, vs. compressor inlet temperature. Thus, a gas turbine is rated for 100% design output at a fixed compressor inlet air temperature—the design inlet air temperature. Because the gas turbine is a high-volume air machine, the compressor power required is usually between 50-70 percent of the total power produced by the turbine. Therefore, the inlet air temperature (or ambient temperature) affects the output of the gas turbine. As the air temperature (inlet temperature) increases above the design temperature, output, i.e. energy production, drops off rapidly. Typically, an increase in the inlet air temperature by 5° F. will reduce the power by about 2 percent. Conversely, energy production is favored by inlet air temperatures below the design inlet air temperature. There is a linear or nearly linear relationship between energy production, i.e. percent of design output, and compressor inlet air temperature, over a significant inlet air temperature range.

This means that the power output of such systems can be expected to vary, seasonally, with wide swings in ambient air temperature. Efficiency is substantially decreased if the ambient air, channeled to the turbine inlet, is hot. In many instances as much as a 30% decrease in the maximum of power output occurs just through a swing of ambient temperature from about 30 to 90° F.

To improve gas turbine operations, systems have been developed for cooling the inlet air to the compressor. Three general methods have been proposed for cooling the inlet air: (1) evaporative cooling; (2) vapor compression refrigeration; and, (3) absorption chillers. See, for example, U.S. Pat. No. 5,203,161. However, such systems increase energy consumption and require significant additional equipment in the form of cooling towers or refrigeration compressors, which is not often feasible or desirable for gas pipelines located in remote and pristine regions, such as Alaska. Therefore, there is a need for an improved air-cooling system that can be used with gas turbines used for pumping natural gas.

The present invention provides such an improved system using a novel integration of a gas turbine with a KALINA CYCLE®. Integrating a gas turbine with a Rankine cycle is amongst the most efficient implementations of gas turbine technology. This arrangement commonly known as the combined cycle is the so-called Brayton-Rankine cycle. In this cycle, gas turbine technology is combined with steam turbine technology. In the combined cycle, the exhaust gas from the gas turbine is used to provide heat to a heat recovery boiler where a working fluid such as water is heated to generate a vapor stream. The vapor stream is subsequently expanded in a turbine to generate additional power. The combination of the two cycles greatly increases the overall fuel efficiency.

The present invention replaces the Rankine cycle with a KALINA CYCLE® in such combined cycle applications for pumping natural gas through pipelines. Because the KALINA CYCLE® uses a refrigerant-type binary fluid mixture such as ammonia-water, a part of the working fluid stream can be throttled to chill the inlet air to the gas turbine compressor.

Thus, according to the invention, a binary fluid KALINA CYCLE® is provided as a bottoming cycle for the gas turbine exhaust and a chiller is integrated with the bottoming cycle to cool the inlet air to the gas turbine compressor. Exhaust gas from the gas turbine preheats, boils and superheats a binary mixture (e.g. ammonia-water) in a heat recovery vapor generator (HRVG). The superheated ammonia-water is expanded in the vapor turbine/generator and exhausts to the KALINA CYCLE® Distillation Condensation Subsystem (DCSS). In the DCSS the binary mixture (discussed as ammonia-water hereinforth but can include other binary systems that would be obvious to use to one of ordinary skill in the art) is distilled utilizing heat from the vapor turbine exhaust. As described more fully below, two concentrations of the binary ammonia-water mixture are condensed in high pressure and low pressure condensers within the DCSS. From the high pressure condenser, the ammonia-water mixture is pumped back to the HRVG completing the closed cycle loop.

To cool the gas turbine inlet air, approximately 5% of the ammonia-water flow to the HRVG is diverted to the air chiller. The saturated liquid is throttled upstream of the air chiller dropping the ammonia-water mixture temperature significantly (for example, in some embodiments, from 26.7° C. to 2.6° C. This ammonia-water stream is then used to cool the gas turbine inlet air in the chiller (for example, from 25° C. to 6° C.). The ammonia-water mixture which is partially boiled leaving the chiller is returned to the KALINA CYCLE® DCSS upstream of the low pressure condenser.

The equipment for use in the present invention can be appropriately designed. For example, heat exchangers and ammonia-water storage tanks can be designed for outdoor installation. Rotating equipment (pumps, vapor turbine, and generator) can be placed in a building for weather and freeze protection.

As noted above, ammonia-water from the Distillation-Condensation Subsystem (DCSS) is preheated, boiled, and superheated in the heat recovery vapor generator. When a compressor station is provided with several gas turbines, each of the operating gas turbines can have an independent HRVG and flow from the several HRVGs can be manifolded to a common vapor turbine and DCSS. The superheated vapor is expanded through the vapor turbine to drive a compressor or generate electric power.

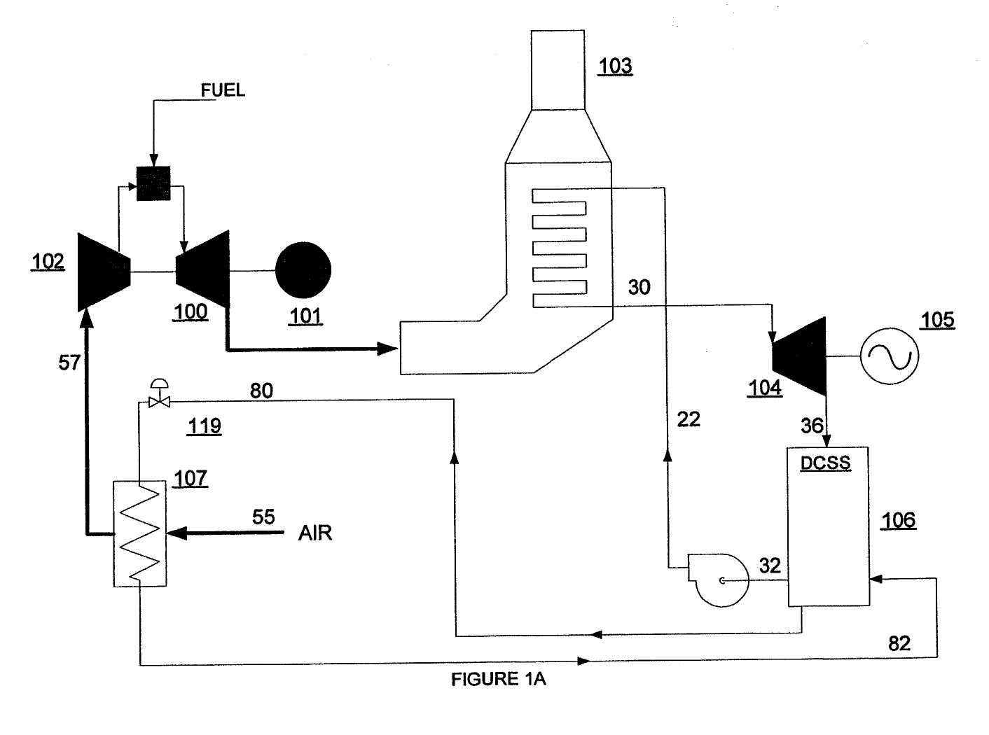

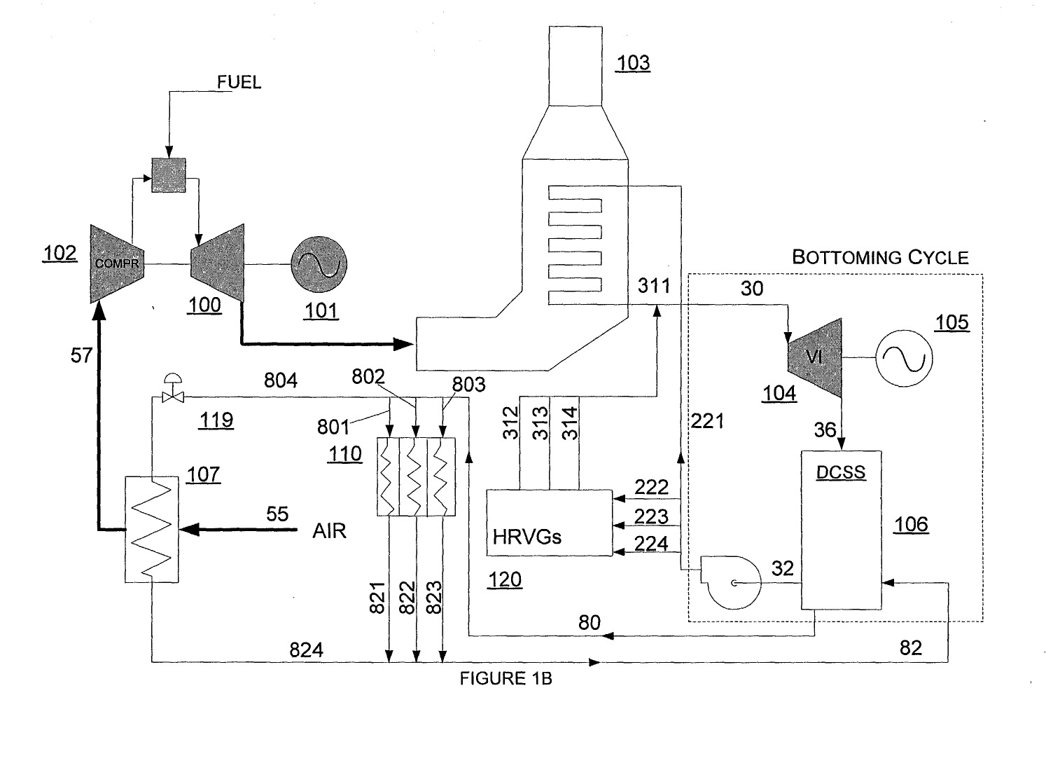

An embodiment of the present invention incorporated in a compressor station for pumping natural gas is shown in a flow diagram form in FIG. 1A. The compressor station comprises at least one gas turbine 100 which drives either a generator 101 or drives a natural gas compressor (not shown), a gas turbine air compressor 102 for compressing an ambient air stream to be input into the gas turbine, a vapor turbine 104 which drives a generator 105 or a natural gas compressor (not shown), a heat recovery vapor generator 103, an air chiller 107 for cooling the ambient air stream that is compressed by the gas turbine air compressor 102 to be fed to the gas turbine 100 and a distillation/condensation sub-system 106. The gas turbine produces a hot gas exhaust stream that is fed to the heat recovery vapor generator 103.

Turning now to the various steps of the cycle shown in FIG. 1A, a heated gaseous working fluid stream 30 including a low boiling point component and a higher boiling point component is expanded in turbine 104 to transform the energy of the working fluid stream into useable form and provide spent stream 36. The spent stream 36 is condensed in a distillation condensation subsystem (DCSS) 106 to provide a low pressure condensed stream (not shown in FIG. 1) and a high pressure split stream 80. The high pressure split stream 80 is passed through the air chiller 107 in heat exchange relationship with an ambient air stream 55 to generate an air chiller outlet stream 82, and the ambient air stream 55 is passed in heat exchange relationship with the high pressure split stream 80 through the air chiller 107 to generate a cooled inlet air stream 57 to be fed to the gas turbine air compressor 102. In some embodiments, the high pressure split stream 80 is throttled using a throttling valve 119 prior to being passed through the air chiller. In a preferred embodiment, the cycle described above is operated such that the temperature of the air chiller outlet stream 82 is controlled using a control system (not shown) so that it does not fall below −2.8° C. to avoid icing on the air side of the chiller

In an alternative embodiment, the gas compressor station is a multi-unit station that comprises more than one gas turbine system. In such a case, each of the gas turbines may include its own HRVG. Flow from the two HRVG's may be manifolded to a common vapor turbine and/or DCSS. Thus, to use the present invention with a multi-unit system, the high pressure split stream 80 is split into multiple streams to supply the air-chiller for each of the gas turbine compressors. An embodiment with a four-unit system is shown in FIG. 1B. As shown in FIG. 1B, the high pressure split stream 80 is split into four streams: a first high pressure split stream 801, a second high pressure split stream 802, a third high pressure split stream 803 and a fourth high pressure split stream 804. Each of these streams supplies the air chiller of a gas turbine air compressor. The figure shows air chiller 107, compressor 102, gas turbine 100 and HRVG 103 for only one of the gas turbine systems. The other three air chillers and gas turbine systems are shown as box 110. After exiting the respective air chillers, air chiller outlet streams 821, 822, 823 and 824 are combined into the air chiller outlet stream 82, which is returned to the bottoming cycle. The working fluid streams 221, 222, 223 and 224 are pumped to each of the HRVGs and the vapor streams 311, 312, 313 and 314 are returned to the bottoming cycle. The figure only shows HRVG 103; the other three HRVGs are shown as box 120. Thus, in the embodiment shown, a single bottoming cycle is combined with four gas turbines. As would be obvious to one of ordinary skill in the art, other combinations are also possible. Thus, two bottoming cycles may be combined with two gas turbines, or alternatively with four gas turbines, etc.

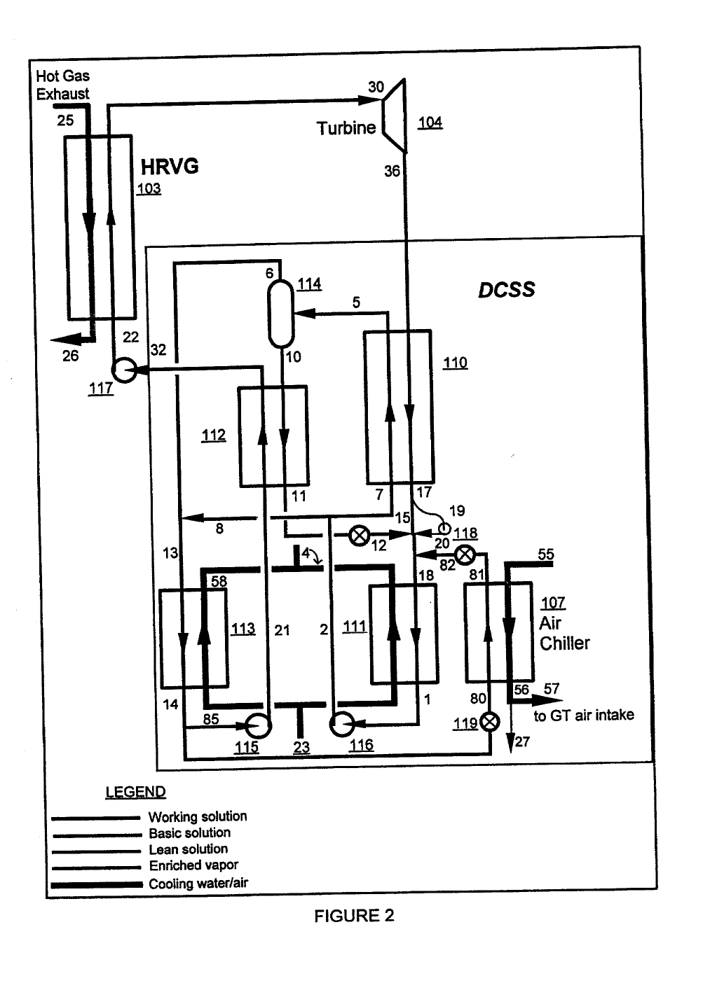

An embodiment of the bottoming cycle integrated with an air chiller is shown in FIG. 2. Referring to FIG. 2, in the cycle shown, a heated gaseous working fluid stream 30 including a low boiling point component and a higher boiling point component is expanded in turbine 104 to transform the energy of the working fluid stream into useable form and provide spent stream 36.

The spent stream 36 is cooled by passing it through a recuperator 110, thereby providing at the outlet of the recuperator 10 a recuperator outlet stream 17. In a preferred embodiment, the recuperator outlet stream 17 comprises a two phase stream which is split into a recuperator liquid stream 19 and a recuperator vapor stream 15 in a drip tank. The recuperator vapor stream 15 flows to the low pressure condenser under the pressure gradient and the recuperator liquid stream 19 is pumped using the recuperator liquid pump 118 to provide adequate energy to overcome friction, static head, and distribution pressure losses.

As will be discussed below, the recuperator outlet stream, or the recuperator vapor stream and recuperator liquid stream, and certain other streams are combined and condensed in a low pressure condenser 111 to generate a low pressure condensed stream 1.

In a preferred embodiment, the low pressure condensed stream 1 is pumped using a condensate pump 116 to generate a high pressure stream 2. The high pressure stream 2 is split using a stream splitter into a first high pressure stream 7 and a second high pressure stream 8. The first high pressure stream 7 is used to cool the spent stream 36 in the recuperator. Thus, prior to being condensed the spent stream 36 is passed through the recuperator 110 in heat exchange relationship with the first high pressure stream 7 to generate the recuperator outlet stream 17, which may comprise a recuperator liquid stream and a recuperator vapor stream, and the first high pressure stream 7 is passed through the recuperator 110 in heat exchange relationship with the spent stream 36 to generate a separator feed stream 5. The separator feed stream 5 is fed to a separator 114 to generate a rich vapor stream 6 and a lean liquid stream 10. The separator 114 can be a flash tank. The rich vapor stream is enriched with respect to the low boiling components and the lean liquid stream is lean with respect to the low boiling components.

The rich vapor stream 6 is combined with the second high pressure stream 8 using a combining system, for example, a manifold, to generate a reconstituted working fluid stream 13, which is passed through a high pressure condenser 113 to generate a high pressure condenser outlet stream 14. The high pressure condenser 113 can be a shell and tube heat exchanger type condenser or a plate-type heat exchanges, which uses cooling water for providing the condensation cooling. Alternatively, it can be an air cooler type heat exchanger, which uses ambient air (through natural or forced convection) for providing the condensation cooling. Thus, in FIG. 2, cooling stream 23 can be air or water. It leaves the high pressure condenser 113 as stream 58.

The high pressure condenser outlet stream 14 is split, using a stream splitter (not shown), into a booster pump inlet stream 85 and the high pressure split stream 80. The booster pump inlet stream 85 is pumped through a booster pump 115 to yield a booster pump outlet stream 21. The booster pump outlet stream 21 is passed through a working fluid preheater 112 in heat exchange relationship with the lean liquid stream 10 to generate a preheated working fluid stream 29 and the lean liquid is passed through the working fluid preheater 112 in heat exchange relationship with the booster pump outlet stream 21 to generate a cooled lean liquid stream 11.

The cooled lean liquid stream 11, the recuperator outlet stream 17 or, alternatively, the recuperator liquid stream 19 and recuperator vapor stream 15, and the air chiller outlet stream 82 are passed through the low pressure condenser 111 to generate the low pressure condensed stream 1. The flow rate of the lean liquid stream 11 from the ammonia-water preheater 112 is manipulated to provide a “basic” composition with a minimum condensation pressure achievable for the given cooling medium or temperature. Consequently, the system maintains a net positive pressure throughout, eliminating the need to routinely scavenge oxygen from air intrusion or to design for vacuum operations.

In one embodiment, the cooled lean liquid stream 11, the recuperator outlet stream 17 or, alternatively, the recuperator liquid stream 19 and recuperator vapor stream 15, and the air chiller outlet stream 82 are combined, in a combining system (not shown), to generate a combined stream 18, which is then passed through the low pressure condenser 111 to generate the low pressure condensed stream 1.

In one embodiment, the recuperator liquid stream 19 is pumped using the recuperator liquid pump 118 prior to being passed through the low pressure condenser 111. Further, the flow rate of the cooled lean liquid stream 11 can be manipulated using a condenser pressure control system (not shown) to control the condensing pressure in the low pressure condenser 111. The low pressure condenser 111 can be a shell and tube heat exchanger or a plate-type heat exchanger, which uses cooling water for providing the condensation cooling. Alternatively, it can be an air cooler type heat exchanger, which uses ambient air (through natural or forced convection) for providing the condensation cooling. Thus, in FIG. 2, cooling stream 23 can be air or water. It leaves the low pressure condenser 111 as stream 4. When the recuperator outlet stream 17 is a two phase stream, the recuperator vapor stream 15 and the recuperator liquid stream 19 are independently manifolded to provide uniform distribution into the low pressure condenser 111, e.g. into the air-cooled condenser bays. Vapor and liquid are then mixed to ensure a uniform composition in each of the flow paths of the condenser.

The preheated working fluid 32 is passed through a heat recovery vapor generator 103 in heat exchange relationship with the hot gas exhaust stream 25 to generate the heated gaseous working fluid stream 30. In one embodiment, the preheated working fluid 32 is pumped using a working fluid pump 117 prior to being passed through the heat recovery vapor generator 103.

The high pressure split stream 80 is throttled prior to being fed to the air chiller 107. The temperature of the air chiller outlet stream 81 is controlled, for example, by manipulating the pressure of the air chiller outlet stream 81. The flow rate of the high pressure split stream 80 can be varied as the ambient temperature changes. In a preferred embodiment, back pressure in the chiller is maintained to provide a minimum ammonia-water temperature of 27° F. (−2.8° C.) to avoid icing on the air-side of the chiller and the flow through the chiller is established to maintain a 10° F. (5.6° C.) temperature approach between the heated ammonia-water and the ambient air.

The system of the invention is characterized by several features:

The pressure of the working fluid throughout the cycle is above ambient, which prevents the intrusion of air that could lead to corrosion of the interior surfaces. In addition, ammonia acts as an excellent oxygen scavenger, further reducing the potential for corrosion on carbon steel surfaces.

The high pressure of the turbine exhaust (relative to conventional Rankine cycles) avoids high volumetric flow rates, resulting in compact turbine design.

The ability to vary the working fluid mixture composition allows the operation of the plant to be optimized for seasonal operation.

The design of the KALINA CYCLE® incorporates the fundamental elements required to provide chilling for the gas turbine inlet air. With the addition of only the cooling coils and appropriate controls, the KALINA CYCLE® design allows the plant operator to cool the gas turbine inlet air during periods of high ambient temperatures, which results in less variation in gas turbine operating conditions, and greater average output from the gas turbine. The inventors' studies suggest that the increased flow rate from the gas turbine allowed by the decrease in inlet air temperature is more than adequate to compensate for the additional heat needed in the DCSS, so that operation of the chiller has, at worst, no net impact on bottoming cycle electrical output.

In an example of the present system, a gas turbine used in a simple cycle at 25° C. ambient air temperature and 50% relative humidity, delivers 33.4 Megawatts (MW). When the same turbine is used with the invention's KALINA CYCLE® system utilizing the gas turbine exhaust heat in a combined cycle plant configuration, an additional 11.2 MW is obtained for the same ambient conditions. Further, as provided by the invention, the output of the gas turbine topping cycle can be increased by chilling the gas turbine inlet air from 25° C. to 6° C. The refrigeration load of the chiller is incorporated into the Kalina bottoming cycle. This results in the additional generation of 4.3 MW, thus improving the gas turbine output from 33.4 MW to 48.9 MW.

In an alternative embodiment, the working fluid in the bottoming cycle can be used to cool the natural gas exiting the outlet of the gas turbine compressor. Thus, the refrigeration capacity of the working fluid is used to cool the natural gas that is being pumped. In such embodiments, the natural gas can be cooled to much lower temperatures than conventional cooling systems.

What may be understood from the foregoing is as follows: In accordance with the present invention, a wide variety of methods and apparatus for pumping natural gas through a gas pipeline are provided. Thus, in one embodiment, the invention is a method for pumping natural gas through a pipeline using a compressor station that comprises a first gas turbine system wherein the gas turbine system comprises a first air compressor that compresses a first ambient air stream, a first combustor, a first turbine and a first heat recovery vapor generator, which method comprises (a) expanding a heated gaseous working fluid stream including a low boiling point component and a higher boiling point component to transform the energy of said stream into useable form and provide a spent stream; (b) condensing said spent stream in a distillation/condensation sub-system to provide a low pressure condensed stream and a high pressure split stream, (c) passing the high pressure split stream through a first air chiller in heat exchange relationship with the first ambient air stream to generate a first air chiller outlet stream; and (d) passing the first ambient air stream in heat exchange relationship with the high pressure split stream through the first air chiller to generate a first cooled inlet air stream to be fed to the first air compressor, wherein the first gas turbine system is used for pumping natural gas through a natural gas pipeline and produces a first hot gas exhaust stream. For example, the first gas turbine can pump natural gas by driving a natural gas compressor. Alternatively, the first gas turbine can drive a generator for generating electricity, which in turn can be used to drive a natural gas compressor. In one embodiment, the first cooled inlet air stream is fed to the first air compressor.

In another version of the above embodiment, the compressor station further comprises a second gas turbine system wherein the second gas turbine system comprises a second air compressor that compresses a second ambient air stream, a second combustor, a second turbine and a second heat recovery vapor generator. Here the method further comprises (a) splitting the high pressure split stream into a first high pressure split stream and a second high pressure split stream; (b) passing the first high pressure split stream through a first air chiller in heat exchange relationship with the first ambient air stream to generate a first air chiller outlet stream; (c) passing the first ambient air stream in heat exchange relationship with the first high pressure split stream through the first air chiller to generate a first cooled inlet air stream to be fed to the first air compressor; (d) passing the second high pressure split stream through a second air chiller in heat exchange relationship with the second ambient air stream to generate a second air chiller outlet stream; and (e) passing the second ambient air stream in heat exchange relationship with the second high pressure split stream through the second air chiller to generate a second cooled inlet air stream to be fed to the second air compressor, wherein the second gas turbine system is used for pumping natural gas through a natural gas pipeline and produces a second hot gas exhaust stream.

In one embodiment, the high pressure stream is throttled prior to step (c). The temperature of the air chiller outlet stream is preferably controlled so that it does not fall below −2.8° C. One method of controlling the temperature of the air chiller outlet stream is by manipulating the pressure of the air chiller outlet stream.

In another embodiment, the low pressure condensed stream is pumped to generate a high pressure stream, which may be split into a first high pressure stream and a second high pressure stream. Further, the spent stream, prior to being condensed, is passed through a recuperator in heat exchange relationship with the first high pressure stream to generate a recuperator outlet stream and the first high pressure stream is passed through the recuperator in heat exchange relationship with the spent stream to generate a separator feed stream. In one embodiment, the recuperator outlet stream is a two phase stream comprising a vapor phase and a liquid phase. Here, the method of the invention may further comprise passing the recuperator outlet stream to a drip tank, wherein said recuperator outlet stream is separated into a recuperator liquid stream and a recuperator vapor stream. Additionally, the separator feed stream may be fed to a separator to generate a rich vapor stream and a lean liquid stream, wherein the rich vapor stream is enriched in the low boiling component and the lean liquid stream is impoverished in the low boiling component.

Further, in one embodiment, the rich vapor stream is combined with the second high pressure stream to generate a reconstituted working fluid stream, which may further be passed through a high pressure condenser to generate a high pressure condenser outlet stream. In this embodiment, the high pressure condenser outlet stream further may be split into a booster pump inlet stream and the high pressure condensed stream. The booster pump inlet stream, in one embodiment, is pumped through a booster pump to yield a booster pump outlet stream, which further may be passed through a working fluid preheater in heat exchange relationship with the lean liquid stream to generate a preheated working fluid stream and the lean liquid is passed through the working fluid preheater in heat exchange relationship with the booster pump outlet stream to generate a cooled lean liquid stream. In one embodiment, the cooled lean liquid stream, the recuperator vapor stream, the recuperator liquid stream and the air chiller outlet stream are passed through the low pressure condenser to generate the low pressure condensed stream. In another embodiment, the cooled lean liquid stream, the recuperator vapor stream, the recuperator liquid stream and the air chiller outlet stream are combined prior to being passed through the low pressure condenser to generate the low pressure condensed stream. The recuperator liquid stream may be pumped prior to being passed through the low pressure condenser, and the flow rate of the cooled lean liquid stream may be manipulated to control the condensing pressure in the low pressure condenser. Preferably, the condensing pressure is manipulated to achieve the maximum turbine output for the given ambient conditions. Additionally, in a preferred embodiment, the step of condensing the spent stream comprises passing the spent stream through a condenser that comprises an air cooler. Preferably, the high pressure condenser and/or the low pressure condenser also comprises an air cooler.

In accordance with the invention, in one embodiment, the preheated working fluid is passed through the first heat recovery vapor generator in heat exchange relationship with the first hot gas exhaust stream to generate the heated gaseous working fluid stream. Preferably, the preheated working fluid is pumped prior to being passed through the first heat recovery vapor generator.

Yet other methods in accordance with the present invention include the following: A method for compressing natural gas through a gas pipeline, which comprises (a) pumping natural gas using at least one gas turbine having an air compressor that produces a hot exhaust gas stream; (b) using the hot gas exhaust stream to heat an ammonia-water mixture that is used as the working fluid in a KALINA CYCLE®; and (c) using a part of the working fluid from the KALINA CYCLE® to cool the inlet air to the air compressor. In a preferred embodiment, step (c) further comprises throttling the part of the working fluid that is used to cool the inlet air to the air compressor.

In yet other embodiment, the invention includes the following apparatus: A compressor station for pumping natural gas having at least one gas turbine driving a natural gas compressor, said gas turbine producing a hot gas exhaust stream, an air compressor for compressing an ambient air stream to be input into the gas turbine, a vapor turbine and a distillation/condensation sub-system, which comprises (a) a turbine for expanding a heated gaseous working fluid stream including a low boiling point component and a higher boiling point component to transform the energy of said stream into useable form and provide a spent stream; (b) a low pressure condenser for condensing said spent stream in said distillation/condensation sub-system to provide a low pressure condensed stream and a high pressure split stream; and (c) an air chiller for passing the high pressure split stream and the ambient air stream through said air chiller in heat exchange relationship with each other to generate an air chiller outlet stream and a cooled inlet air stream to be fed to the gas turbine compressor. In a preferred embodiment, the compressor station according to the invention, further comprises a throttling valve for throttling the high pressure stream prior to step (c).

The compressor station according to the above embodiment may further comprise a control system for controlling the temperature of the air chiller outlet stream so that it does not fall below −2.8° C. to avoid icing on the air-side of the chiller. In a preferred embodiment, the control system controls the temperature of the air chiller outlet stream by manipulating the pressure of the air chiller outlet stream. Additionally, the compressor station may comprise a condensate pump for pumping the low pressure condensed stream to generate a high pressure stream. The compressor station may also comprise a splitter for splitting the high pressure stream into a first high pressure stream and a second high pressure stream. In a preferred embodiment, the compressor station further comprises a recuperator for passing the spent stream and the first high pressure stream in heat exchange relationship with each other through said recuperator to generate a recuperator outlet stream and a separator feed stream. The recuperator outlet stream may further comprise a recuperator liquid stream and a recuperator vapor stream.

In another embodiment, the compressor station further comprises a separator wherein the separator feed stream is fed to said separator to generate a rich vapor stream and a lean liquid stream. Additionally, the compressor station may comprise a combining system for combining the rich vapor stream with the second high pressure stream to generate a reconstituted working fluid stream. The combining system may be a manifold in one embodiment. The compressor station may also comprise a high pressure condenser wherein the reconstituted working fluid stream is passed through said high pressure condenser to generate a high pressure condenser outlet stream. In one embodiment, the compressor station further comprises a splitter wherein the high pressure condenser outlet stream is split into a booster pump inlet stream and the high pressure split stream. Also provided may be a booster pump for pumping the booster pump inlet stream to yield a booster pump outlet stream. In another embodiment, the compressor station further comprises a working 45, fluid preheater wherein the booster pump outlet stream and the lean liquid stream are passed through said working fluid preheater in heat exchange relationship with each other to generate a preheated working fluid stream and a cooled lean liquid stream. In a preferred embodiment, the cooled lean liquid stream, the recuperator vapor stream, the recuperator liquid stream and the air chiller outlet stream are passed through the low pressure condenser to generate the low pressure condensed stream. Additionally, a combining system is provided for combining the cooled lean liquid stream, the recuperator vapor stream, the recuperator liquid stream and the air chiller outlet stream are combined to form a combined stream prior to being passed through the low pressure condenser to generate the low pressure condensed stream. The compressor station may further comprise a recuperator liquid pump for pumping the recuperator liquid stream to the low pressure condenser. Preferably, the compressor station comprises a condenser pressure control system wherein the condensing pressure in the low pressure condenser is controlled by manipulating the flow rate of the cooled lean liquid stream.

The compressor station according to the invention may further comprise a heat recovery vapor generator wherein the preheated working fluid and the hot gas exhaust stream are passed through the heat recovery vapor generator in heat exchange relationship with each other to generate the heated gaseous working fluid stream. A working fluid pump is provided for pumping the preheated working fluid through the heat recovery vapor generator.

Yet another apparatus in accordance with the present invention includes the following: An apparatus for compressing natural gas through a gas pipeline, which comprises (a) at least one gas turbine having an air compressor that produces a hot exhaust gas stream; (b) a KALINA CYCLE® that uses the hot gas exhaust stream to heat an ammonia-water mixture that is used as the working fluid in said KALINA CYCLE®; and (c) a system for using a part of the working fluid from the KALINA CYCLE® to cool the inlet air to said air compressor. Preferably, the system for using said part of the working fluid further comprises a throttle valve for throttling the part of the working fluid used to cool the inlet air to the air compressor.

While various preferred embodiments of the present invention have been disclosed for illustrative purposes, those skilled in the art will appreciate a number of variations and modifications therefrom and it is intended within the appended claims to cover all such variations and modifications as fall within the true spirit and scope of the present invention.

What is claimed is:

1. A method for pumping natural gas through a pipeline using a compressor station that comprises a first gas turbine system wherein the gas turbine system comprises a first air compressor that compresses a first ambient air stream, a first combustor, a first turbine and a first heat recovery vapor generator, the method comprising:
(a) expanding a heated gaseous working fluid stream including a low boiling point component and a higher boiling point component to transform the energy of said stream into useable form and provide a spent stream;
(b) condensing said spent stream in a distillation/condensation sub-system to provide a low pressure condensed stream and a high pressure split stream,
(c) passing the high pressure split stream through a first air chiller in heat exchange relationship with the first ambient air stream to generate a first air chiller outlet stream; and
(d) passing the first ambient air stream in heat exchange relationship with the high pressure split stream through the first air chiller to generate a first cooled inlet air stream to be fed to the first air compressor,
wherein the first gas turbine system is used for pumping natural gas through a natural gas pipeline and produces a first hot gas exhaust stream.

2. The method according to claim 1, wherein the first gas turbine system drives a natural gas compressor.

3. The method according to claim 1, wherein the compressor station further comprises a second gas turbine system wherein the second gas turbine system comprises a second air compressor that compresses a second ambient air stream, a second combustor, a second turbine and a second heat recovery vapor generator, the method further comprising:
(a) splitting the high pressure split stream into a first high pressure split stream and a second high pressure split stream;
(b) passing the first high pressure split stream through a first air chiller in heat exchange relationship with the first ambient air stream to generate a first air chiller outlet stream;
(c) passing the first ambient air stream in heat exchange relationship with the first high pressure split stream through the first air chiller to generate a first cooled inlet air stream to be fed to the first air compressor;
(d) passing the, second high pressure split stream through a second air chiller in heat exchange relationship with the second ambient air stream to generate a second air chiller outlet stream; and
(e) passing the second ambient air stream in heat exchange relationship with the second high pressure split stream through the second air chiller to generate a second cooled inlet air stream to be fed to the second air compressor,
wherein the second gas turbine system is used for pumping natural gas through a natural gas pipeline and produces a second hot gas exhaust stream.

4. The method according to claim 1, wherein the high pressure stream is throttled prior to step (c).

5. The method according to claim 1, wherein the temperature of the air chiller outlet stream is controlled so that it does not fall below −2.8° C.

6. The method of claim 5, wherein the temperature of the air chiller outlet stream is controlled by manipulating the pressure of the air chiller outlet stream.

7. The method of claim 1 wherein the low pressure condensed stream is pumped to generate a high pressure stream.

8. The method of claim 7 wherein the high pressure stream is split into a first high pressure stream and a second high pressure stream.

9. The method of claim 8 wherein prior to being condensed the spent stream is passed through a recuperator in heat exchange relationship with the first high pressure stream to generate a recuperator outlet stream and the first high pressure stream is passed through the recuperator in heat exchange relationship with the spent stream to generate a separator feed stream.

10. The method of claim 9 wherein the recuperator outlet stream is a two phase stream comprising a vapor phase and a liquid phase.

11. The method of claim 8 further comprising passing the recuperator outlet stream to a drip tank, wherein said recuperator outlet stream is separated into a recuperator liquid stream and a recuperator vapor stream.

12. The method of claim 9 wherein the separator feed stream is fed to a separator to generate a rich vapor stream and a lean liquid stream, wherein the rich vapor stream is enriched in the low boiling component and the lean liquid stream is impoverished in the low boiling component.

13. The method of claim 12 wherein the rich vapor stream is combined with the second high pressure stream to generate a reconstituted working fluid stream.

14. The method of claim 13 wherein the reconstituted working fluid stream is passed through a high pressure condenser to generate a high pressure condenser outlet stream.

15. The method of claim 14 wherein the high pressure condenser outlet stream is split into a booster pump inlet stream and the high pressure condensed stream.

16. The method of claim 15 wherein the booster pump inlet stream is pumped through a booster pump to yield a booster pump outlet stream.

17. The method of claim 16 wherein the booster pump outlet stream is passed through a working fluid preheater in heat exchange relationship with the lean liquid stream to generate a preheated working fluid stream and the lean liquid is passed through the working fluid preheater in heat exchange relationship with the booster pump outlet stream to generate a cooled lean liquid stream.

18. The method of claim 17 wherein the cooled lean liquid stream, the recuperator vapor stream, the recuperator liquid stream and the air chiller outlet stream are passed through the low pressure condenser to generate the low pressure condensed stream.

19. The method of claim 17 wherein the cooled lean liquid stream, the recuperator vapor stream, the recuperator liquid stream and the air chiller outlet stream are combined prior to being passed through the low pressure condenser to generate the low pressure condensed stream.

20. The method of claim 18 wherein the recuperator liquid stream is pumped prior to being passed through the low pressure condenser.

21. The method of claim 18 wherein the flow rate of the cooled lean liquid stream is manipulated to control the condensing pressure in the low pressure condenser.

22. The method of claim 1 wherein the step of condensing the spent stream comprises passing the spent stream through a condenser that comprises an air cooler.

23. The method of claim 14 wherein the high pressure condenser comprises an air cooler.

24. The method of claim 18 wherein the low pressure condenser comprises an air cooler.

25. The method of claim 17 wherein the preheated working fluid is passed through the first heat recovery vapor generator in heat exchange relationship with the first hot gas exhaust stream to generate the heated gaseous working fluid stream.

26. The method of claim 25 wherein the preheated working fluid is pumped prior to being passed through the first heat recovery vapor generator.

27. The method of claim 1 wherein the first cooled inlet air stream is fed to the first air compressor.

28. A method for compressing natural gas through a gas pipeline, the method comprising:
(a) pumping natural gas using at least one gas turbine having an air compressor that produces a hot exhaust gas stream;
(b) using the hot gas exhaust stream to heat an ammonia-water mixture that is used as the working fluid in a KALINA CYCLE®; and
(c) using a part of the working fluid from the KALINA CYCLE® to cool the inlet air to said air compressor.

29. The method according to claim 28, wherein step (c) further comprises throttling said part of the working fluid.

30. A compressor station for pumping natural gas having at least one gas turbine driving a natural gas compressor, said gas turbine producing a hot gas exhaust stream, an air compressor for compressing an ambient air stream to be input into the gas turbine, a vapor turbine and a distillation/condensation sub-system, the compressor station further comprising:
(a) a turbine for expanding a heated gaseous working fluid stream including a low boiling point component and a higher boiling point component to transform the energy of said stream into useable form and provide a spent stream;
(b) a low pressure condenser for condensing said spent stream in said distillation/condensation sub-system to provide a low pressure condensed stream and a high pressure split stream; and
(c) an air chiller for passing the high pressure split stream and the ambient air stream through said air chiller in heat exchange relationship with each other to generate an air chiller outlet stream and a cooled inlet air stream to be fed to the gas turbine compressor.

31. The compressor station according to claim 30, further comprising a throttling valve for throttling the high pressure stream prior to step (c).

32. The compressor station according to claim 30, further comprising a control system for controlling the temperature of the air chiller outlet stream so that it does not fall below −2.8° C.

33. The compressor station according to claim 32, wherein the control system controls the temperature of the air chiller outlet stream by manipulating the pressure of the air chiller outlet stream.

34. The compressor station according to claim 30, further comprising a condensate pump for pumping the low pressure condensed stream to generate a high pressure stream.

35. The compressor station of claim 34 further comprising a splitter for splitting the high pressure stream into a first high pressure stream and a second high pressure stream.

36. The compressor station of claim 35 further comprising a recuperator for passing the spent stream and the first high pressure stream in heat exchange relationship with each other through said recuperator to generate a recuperator outlet stream and a separator feed stream.

37. The compressor station of claim 36 wherein the recuperator outlet stream further comprises a recuperator liquid stream and a recuperator vapor stream.

38. The compressor station of claim 36 further comprising a separator wherein the separator feed stream is fed to said separator to generate a rich vapor stream and a lean liquid stream.

39. The compressor station of claim 38 further comprising a combining system for combining the rich vapor stream with the second high pressure stream to generate a reconstituted working fluid stream.

40. The compressor station of claim 39 wherein the combining system is a manifold.

41. The compressor station of claim 39 further comprising a high pressure condenser wherein the reconstituted working fluid stream is passed through said high pressure condenser to generate a high pressure condenser outlet stream.

42. The compressor station of claim 41 further comprising a splitter wherein the high pressure condenser outlet stream is split into a booster pump inlet stream and the high pressure split stream.

43. The compressor station of claim 42 further comprising a booster pump for pumping the booster pump inlet stream to yield a booster pump outlet stream.

44. The compressor station of claim 43 further comprising a working fluid preheater wherein the booster pump outlet stream and the lean liquid stream are passed through said working fluid preheater in heat exchange relationship with each other to generate a preheated working fluid stream and a cooled lean liquid stream.

45. The compressor station of claim 44 wherein the cooled lean liquid stream, the recuperator vapor stream, the recuperator liquid stream and the air chiller outlet stream are passed through the low pressure condenser to generate the low pressure condensed stream.

46. The compressor station of claim 44 further comprising a combining system for combining the cooled lean liquid stream, the recuperator vapor stream, the recuperator liquid stream and the air chiller outlet stream are combined to form a combined stream prior to being passed through the low pressure condenser to generate the low pressure condensed stream.

47. The compressor station of claim 45 further comprising a recuperator liquid pump for pumping the recuperator liquid stream to the low pressure condenser.

48. The compressor station of claim 45 further comprising a condenser pressure control system wherein the condensing pressure in the low pressure condenser is controlled by manipulating the flow rate of the cooled lean liquid stream.

49. The compressor station according to claim 30 wherein the condensers for condensing the spent stream are air coolers.

50. The compressor station of claim 41 wherein the high pressure condenser is an air cooler.

51. The compressor station of claim 45 wherein the low pressure condenser is an air cooler.

52. The compressor station of claim 44 further comprising a heat recovery vapor generator wherein the preheated working fluid and the hot gas exhaust stream are passed through said heat recovery vapor generator in heat exchange relationship with each other to generate the heated gaseous working fluid stream.

53. The compressor station of claim 52 further comprising a working fluid pump for pumping the preheated working fluid through the heat recovery vapor generator.

54. An apparatus for compressing natural gas through a gas pipeline, the apparatus comprising:
(a) at least one gas turbine having an air compressor, the gas turbine producing a hot exhaust gas stream;
(b) a KALINA CYCLE® that uses the hot gas exhaust stream to heat an ammonia-water mixture that is used as the working fluid in said KALINA CYCLE®; and
(c) a system for using a part of the working fluid from the KALINA CYCLE® to cool the inlet air to said air compressor.

55. The apparatus of claim 54, wherein the system for using said part of the working fluid further comprises a throttle valve for throttling said part of the working fluid.
